(19) United States
(12) Patent Application Publication
(10) Pub. No.: US 2007/0228722 A1
(43) Pub. Date: Oct. 4, 2007

(54) Device for Attaching a Componet to a Hollow Body and Fuel System for Motor Vehicles Using the Device

(75) Inventors: Paul Plissart, Tervuren (BE); Bjorn Criel, Merelbeke (BE); Simon Bousquet, Bruxelles (BE)

Correspondence Address: OBLON, SPIVAK, MCCLELLAND, MAIER & NEUSTADT, P.C., 1940 DUKE STREET, ALEXANDRIA, VA, 22314, US

(73) Assignee: INERGY AUTO SYSTEMS RESEARCH (SOCIETE ANONYME), Brussels (BE)

(21) Appl. No.: 11/579,494

(22) PCT Filed: May 3, 2005
(86) PCT No.: PCT/EP05/52019

§ 371 Date: Nov. 3, 2006

(30) Foreign Application Priority Data
May 7, 2004 (FR) 04.04998

(51) Int. Cl. F16L 25/00

(52) U.S. Cl. 285/9.2

(57) ABSTRACT

Device and associated method for attaching a component (1) to a hollow body with a wall (4) made of plastic of multilayer structure comprising at least one layer of barrier material (5), the device comprising one or more O-ring seals (6) arranged in a groove formed at the periphery of the component (1) or in the wall (4) of the hollow body, at least one of the O-ring seals (6) being compressed radially and being in contact with the layer of barrier material (5). Fuel system for motor vehicles comprising a tank and at least one component (1) attached to the tank by this device.

The subject of the present invention relates to a device for attaching a component to a hollow body. The invention also relates to a method of attachment and to a fuel system for a motor vehicle.

Liquid and gas tanks in use in industry or carried on board vehicles of various kinds generally have to satisfy sealing and permeability standards related to the type of use for which they are designed and the requirements in terms of environmental considerations that they have to meet. There is currently, both in Europe and throughout the world, a considerable tightening of requirements regarding the limitation on the emissions of pollutants into the atmosphere and into the environment in general (for example PZEV “Partial Zero Emission Vehicle” standards in California). In addition, the limits on permissible emissions have become so small that the losses associated with leaks and permeability at the interfaces between the accessories and the tank are now responsible for a higher relative proportion of the total losses in the tank plus accessories system.

Furthermore, use is increasingly commonly being made of tanks of a multilayer structure including one or more layers of an impermeable or barrier material. Incorporating components into such tanks presents the problem of attaching them in a sealed and impermeable way to an opening made in these tanks. The problem is that having a tank and a component each of which has a low level of permeability is not enough to guarantee that the level of permeability at their mutual interface will also be low.

In order to solve this problem of permeability at the interfaces between component and tank, various techniques for attaching a component to a tank are already known. For example:
welding the component to the wall of the tank, the welded component having beforehand been treated (for example by sulphonation) or being made of two materials,
mechanically attaching the component to the tank with the presence of one or several fields at the component/tank interface, these seals most of the time being compressed axially, that is to say compressed along an axis normal to the wall of the tank at the point of contact between the seal and the wall of the tank.

Even in the case of a tank with a multilayer structure comprising a layer of impermeable material, axial compression gives rise to fairly high permeability because there is a leakage path, that the vapours or liquid contained in the tank can follow, circumnavigating the layer of impermeable material.

However, these solutions usually have the disadvantage of a high cost and/or that of high permeability. What is more, in the case of a permanent attachment of the component to the tank, it is not possible for the component to be replaced easily without damaging the attachment device itself.

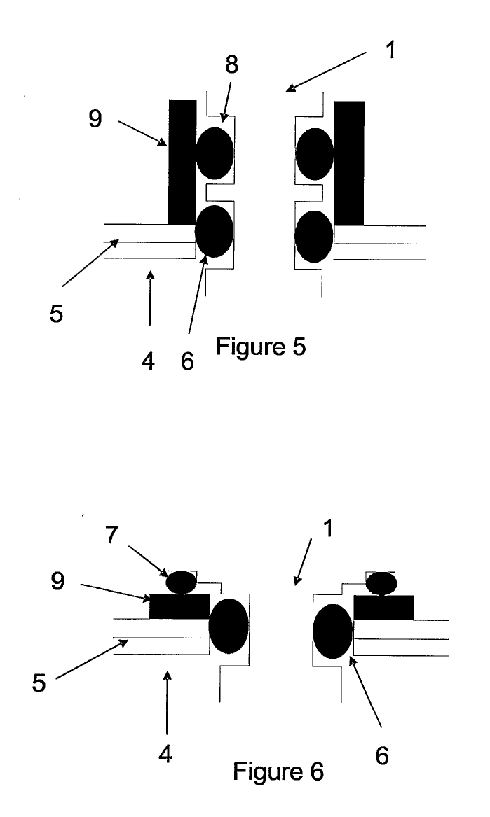

Patent Application EP 1314603 discloses a device which comprises a pin and a single O-ring seal. The O-ring seal is compressed not radially but axially. Even in the case where the wall of the tank is of multilayer structure and comprises a layer of barrier material, the example disclosed in FIG. 5 of the application confirms the presence of a leakage path between the seal and the barrier layer because there is no effective contact between these: the problem of permeability at the interface is therefore not solved satisfactorily. The device furthermore comprises several elements, is complicated, and is expensive.

In the Derwent abstract 2003-610804 of Japanese Patent Application 2003025857, a component of tubular shape and comprising annular O-ring seals is fixed to the wall of a fuel tank but without passing through its wall. The wall of the tank is of multilayer structure and comprises a layer of barrier material but these seals are not in direct contact with this layer: there remains a leakage path for the hydrocarbons through the layer that separates the seals from the layer of barrier material.

The object of the present invention is to provide a device for attaching a component to a hollow body with a wall—particularly a fuel tank or a pipe, that effectively limits losses of liquid and gas by comparison with the conventional attachment devices.

To this end, the invention relates to a device for attaching a component to a hollow body with a wall made of plastic of multilayer structure comprising at least one layer of thermoplastic and at least one layer of barrier material, the device comprising one or more O-ring seals each placed in a groove formed at the periphery of the component or in the wall of the hollow body, at least one of the O-ring seals being compressed radially and being in contact with the barrier layer of the hollow body.

A component is to be understood to mean any part obtained by a shaping technique such as, for example, blow moulding or injection moulding or any other technique known to those skilled in the art. Advantageously and nonlimitingly, the component may be chosen from a pipette, an end piece, a neck, a valve, a gauge/pump module base, an electrical connector or a sensor.

A hollow body is to be understood as meaning any structure the surface of which has at least one empty or concave part. In the context of the invention, this will preferably be tanks or pipes.

A tank is considered to mean any hollow body defining a space delimited by a completely or partially closed surface, able to contain a liquid or a gas. The tank is generally manufactured by extrusion-moulding and, as a preference, by extrusion-blow-moulding.

In particular, the tank may be a fuel tank. A fuel tank is to be understood as meaning any type of tank capable of storing a liquid and/or gaseous fuel under varying pressure and temperature conditions. More specifically targeted are tanks of the type encountered in motor vehicles. The expression “motor vehicle” includes cars, motorcycles and trucks.

The pipe may, for example, be the filler pipe used to fill the fuel tank. The fuel tank filler pipe is generally a duct made of plastic, single layer or multilayer, which connects the fuel tank to a point situated at a level usually higher up than the tank and via which the tank can be refilled with fuel.

According to the invention, the device comprises one or more O-ring seals arranged in a groove formed at the periphery of a part of the component or in the wall of the hollow body. A peripheral groove preferably corresponds to each O-ring seal considered in the device. By arranging an O-ring seal in a groove, the movements of the seal at the component/hollow body interface are limited and the risk of leakage at this same interface is reduced also. The grooves are preferentially formed on the component because in such a case the O-ring seals are easier to fit.

The O-ring seal is advantageously made of an elastomer, preferably a fluoroelastomer because this material has good properties of resistance when in contact with fuels in liquid or gaseous form.

In the device according to the invention at least one of the O-ring seals is compressed radially when the component is attached to the hollow body.

In this device, the component also passes through the wall of the hollow body. For that, an opening (which may or may not be circular in shape) is generally made in the wall of the hollow body using any technique known to those skilled in the art, such as, for example: boring a hole through the wall, pricking during blowing (that is to say generating the hole using the needle that is used to pierce the wall at the end of moulding in order to let out the gases), or generating an appropriate geometry when blowing the hollow body. It has indeed been observed that, surprisingly, a hole produced by pricking made it possible to obtain a flush-fitting barrier layer. In general, obtaining the opening at the time of blowing is advantageous. If the technique used to produce the opening in the wall does not allow the desired geometry to be obtained, the opening may subsequently be machined.

When one or more O-ring seals are arranged on the component, the part of the component comprising the O-ring seal(s) advantageously has a profile such that, when the component is attached to the hollow body, this part passes through the wall of the hollow body at the site of the opening in the hollow body so that at least one seal is in direct contact with the wall of the hollow body.

In a first particular embodiment, the component and the hollow body comprise attachment means. When the component is fixed to the hollow body, the means of attachment of the component collaborate with those of the hollow body so as to prevent the component and the hollow body from becoming detached. In the particular case where the hollow body is a fuel tank the attachment device makes it possible to withstand the stresses applied to the tank, and is for example resistant to crashes, temperature cycles, to the vehicle rolling over.

In another alternative form of the device according to the invention, the means of attachment of the hollow body press against the periphery of an opening in the hollow body.

As a preference, the component and its means of attachment and the means of attachment of the hollow body are made of plastic.

Plastic is understood to mean any synthetic polymer material, whether thermoplastic or thermosetting, which is in the solid state under ambient conditions, as well as blends of at least two of these materials. The intended polymers comprises both homopolymers and copolymers (especially binary or ternary copolymers). Examples of such copolymers are, non-limitingly: random copolymers, linear block copolymers and other block copolymers, and graft copolymers. Thermoplastic polymers, including thermoplastic elastomers, and blends thereof, are preferred.

Any type of thermoplastic polymer or copolymer whose melting point is below the decomposition temperature is suitable. Synthetic thermoplastics, which have a melting range spread over at least 10 degrees Celsius, are particularly suitable. Examples of such materials include those that exhibit polydispersion in their molecular weight.

The polymer often employed is polyethylene. Excellent results have been obtained with high-density polyethylene (HDPE). Particularly for the means of attachment of the hollow body.

The component and its means of attachment according to the invention generally contain polyolefins, graft polyolefins, thermoplastic polyesters, polyketones, polyamides and copolymers thereof. Use is advantageously made of POM (polyoxymethylene) as the material for the component and of polyethylene for the material of the means of attachment secured to the hollow body.

According to the invention, the wall of the hollow bodies made of plastic has a multilayer structure comprising at least one layer of a thermoplastic and at least one layer of a barrier material, that is to say of a material, generally of polymeric nature, which has very good impermeability to certain liquids and gases.

A barrier material may be incorporated into one of the layers of the wall of the hollow body or a special additional layer essentially consisting of a barrier material may be inserted within the structure. As a preference, an additional layer essentially consisting of a barrier material is inserted within the structure.

Examples of barrier materials are, non-limitingly: resins based on polyamides or copolyamides, random ethylene/vinyl alcohol copolymers (EVOH) or thermotropic liquid-crystal polymers, such as copolyesters of p-hydroxybenzoic acid and 6-hydroxy-2-naphthoic acid and copolyesters of p-hydroxybenzoic acid with terephthalic acid and 4,4′-biphenol (for example the copolyesters sold under the brand name XYDAR®).

In another particular embodiment, the means of attachment of the hollow body are secured to the outer layer of the wall of the hollow body. As a preference the means of attachment of the hollow body are welded to the outer layer of the wall of the hollow body. What that means is that the component and the hollow body are secured together by bringing the molecules of a portion of the surface of one end of the component, that forms a joining surface, into contact and partial molecular interpenetration with the molecules of a similar surface belonging to the wall of the hollow body.

The means of attachment are advantageously secured to the wall of the hollow body by increasing the temperature in the welding regions, for example by heating these regions beforehand. The mirror welding technique has yielded excellent results.

In order to reduce still further the level of permeability of the attachment device according to the invention, recourse may be had to treating the component using an appropriate process, for example a sulphonation process.

Furthermore, the device may preferably comprise at least one O-ring seal compressed axially and arranged between the component and the hollow body. This seal contributes to reducing the leaks between the component and the hollow body, particularly in the presence of temperature variations: these may give rise to dimensional changes in the component and/or the hollow body and encourage leakage paths at their interface. The seal is also effective in situations where the component is subject to the influence of vibrations.

According to the invention, at least one O-ring seal is in contact with the barrier layer. The fact that the seal is in contact with the barrier layer of the wall of the hollow body makes it possible to reduce leaks of gas or liquid at the interface between the component and the hollow body.

The radial compression of the O-ring seals gives excellent results in terms of reducing the permeability because that makes it possible to reduce the distance between the seal and the barrier layer, through the opening made in the hollow body. Axial compression, on the wall of the hollow body, would, for its part, give rise to a significant distance between the barrier layer and the seal, and hence to higher permeability.

Furthermore, given the phenomena of deformation and ageing of the polymer structures, it is necessary to dimension the thickness of the seals (or more precisely, the chord thickness) appropriately, so as to maintain satisfactory compression throughout the life of the device. Radially compressing a seal whose chord thickness is close to or even greater than the wall thickness of the hollow body may prove tricky.

In one particular embodiment of the invention, the device comprises an element equipped with an opening corresponding to an opening in the hollow body and secured (for example by welding or mechanical anchoring) to the wall of the hollow body in such a way that the two openings are in the continuation of one another. In this case, the component that is attached to the hollow body passes through the thickness of the element and the wall of the hollow body. This element may constitute, at least in part, the aforementioned means of attachment of the hollow body.

The opening in the element may be produced at the same time as the opening is made in the wall of the hollow body, for example by boring, through the element and through the wall. The element is preferably injection moulded so that after boring it exhibits a surface finish that is ideal for a seal to press against.

The thickness of the element (the dimension measured along the normal to the wall of the hollow body) is chosen such that the sum of the thickness of the element and the thickness of the wall is greater than the compression zone of the seal compressed radially and in contact with the layer of barrier material of the tank. This then guarantees sufficient height for the seal to press against.

The use of an additional element equipped with an opening and secured to the wall of the hollow body also proves advantageous in the case where the device comprises more than one O-ring seal because seals other than the one in contact with the barrier layer can be compressed (radially or axially) between the component and the element. Such systems (with an additional element and several seals) generally exhibit the advantage of improved mechanical strength (especially in torsion) and an ability to compensate for the play in the various parts that are to be assembled. In particular, the variants whereby at least one O-ring seal is compressed axially and arranged either between the component (1) and the wall (4) of the hollow body or between the component (1) and the element (9) are preferred.

A plastic that is impermeable to hydrocarbons is advantageously chosen for the element. The latter is preferably solid

It is also possible to include in the element a profile that allows mechanical immobilization preventing any possible expansion of the wall of the hollow body and thus guaranteeing better stability of the compression of the radial seal.

The invention also relates to a method of attachment of a component to a hollow body using the device described hereinabove, a part of the component being inserted into an opening in the hollow body, in such a way that at least one O-ring seal arranged in a groove formed at the periphery of the component or in the wall of the hollow body is compressed radially and is in contact with the layer of barrier material of the hollow body.

The invention also relates to a fuel system for motor vehicles comprising a tank and at least one component attached to the tank by means of the device for attaching a component as described hereinabove.

The figures which follow are given with a view to illustrating the invention without wishing to restrict its scope.

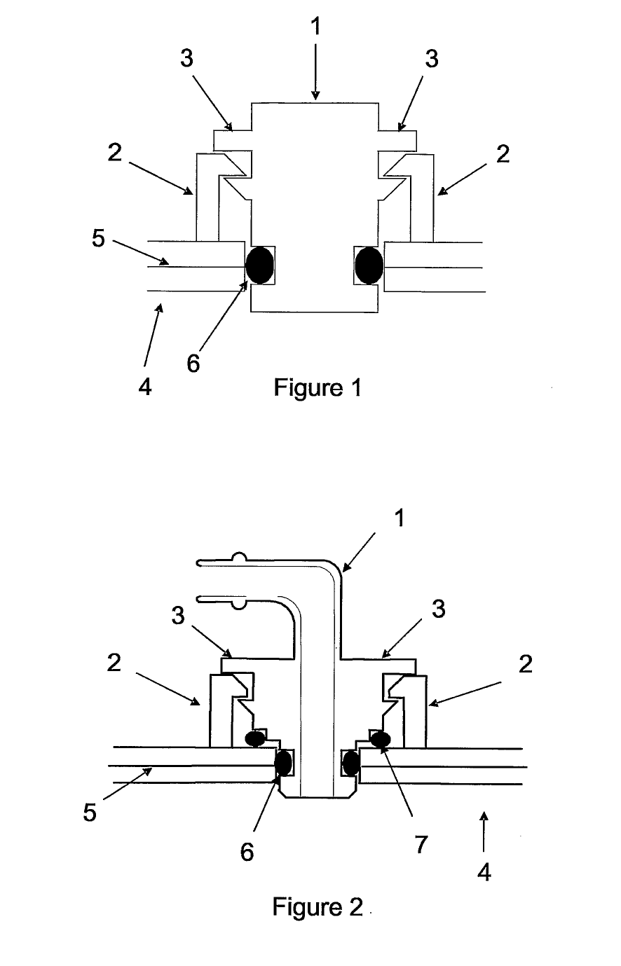

FIG. 1 relates to a device comprising a component (1) provided with means of attachment (3) which collaborate with means of attachment (2) secured to the wall (4) of a tank. The O-ring seal (6) is in direct contact with the layer of barrier material (5). The opening in the tank has been produced, for example, by boring.

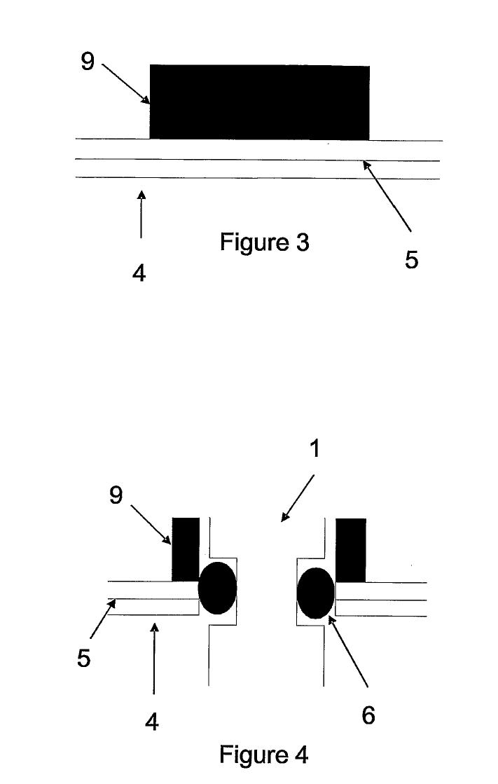

FIG. 2 corresponds to the case where the device comprises an O-ring seal (6) compressed radially and an O-ring seal (7) compressed axially. The seal (6) is in direct contact with the layer of barrier material (5).

FIG. 3 illustrates the embodiment where an injected solid element (9) is secured to the wall (4) of the tank.

FIGS. 4 to 6 illustrate cases where the solid element (9) is equipped with an opening positioned in the continuation of that of the tank and where the edge of this opening supports an O-ring seal, which may be either the seal (6) in contact with the barrier layer of the wall of the tank or with the at least one additional seal (7) or (8).

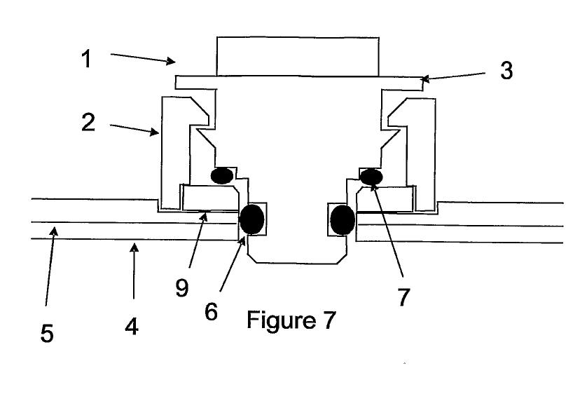

FIG. 7 depicts the application of the device to a bent pipette where the seal (7) is compressed axially on the element (9).

1-11. (canceled)

12. A device for attaching a component to a hollow body with a wall made of plastic of multilayer structure comprising at least one layer of thermoplastic and at least one layer of barrier material, a part of the component being inserted in an opening in the wall of the hollow body, the device comprising:
one or more O-ring seals each placed in a groove formed at the periphery of the component or in the wall of the hollow body, at least one of the O-ring seals being compressed radially and being in contact with the barrier layer of the hollow body, and
an element equipped with an opening corresponding to an opening in the hollow body and which is secured to the wall of the hollow body in such a way that the two openings are in the continuation of one another and in that at least one O-ring seal is completely or partially-compressed between the component and the element.

13. The device according to claim 12, wherein the component and the hollow body each comprise an attachment device which collaborate with one another.

14. The device according to claim 12, wherein the attachment device of the hollow body presses against the periphery of the opening.

15. The device according to claim 13, wherein the component and its attachment device and the attachment device of the hollow body are made of plastic.

16. The device according to claim 15, wherein the plastic of the attachment device of the hollow body is high density polyethylene (HDPE).

17. The device according to claim 12, wherein the attachment device of the hollow body is secured to an outer layer of the wall of the hollow body.

18. The device according to claim 12, wherein the component is treated to reduce the permeability.

19. The device according to claim 12, wherein the component is selected from the group consisting of a pipe, a pipette, an end piece, a neck, a valve, a gauge/pump module base, an electrical connector and a sensor.

20. The device according to claim 12, wherein the hollow body is a pipe or a tank.

21. The device according to claim 12, further comprising at least one O-ring seal compressed axially and arranged either between the component and the wall of the hollow body or between the component and the element.

22. A fuel system for motor vehicles comprising a tank, a pipe, and at least one component, the component being attached to the tank or to the pipe by the device according to claim 12.
